(19) United States
(12) Patent Application Publication
(10) Pub. No.: US 2025/0003851 A1
(43) Pub. Date: Jan. 2, 2025

(54) RHEOMETER FOR SIMULTANEOUS RHEOLOGICAL AND ELECTRICAL MEASUREMENTS

(71) Applicant: TA Instruments-Waters LLC, New Castle, DE (US)

(72) Inventors: Scott Merrullo, Philadelphia, PA (US); Kevin Whitcomb, Newark, DE (US); Jeremy May, Wilmington, DE (US)

(21) Appl. No.: 18/599,353

(22) Filed: Mar. 8, 2024

Related U.S. Application Data
(60) Provisional application No. 63/523,585, filed on Jun. 27, 2023.

(51) Int. Cl. G01N 11/14; G01N 11/00

(52) U.S. Cl. CPC G01N 11/14; G01N 11/142; G01N 2011/0066

(57) ABSTRACT

Described is an apparatus for measuring rheological and electrical properties of a sample. The apparatus includes a first geometry comprising a first and a second stationary element each being electrically conductive and having a surface disposed to face the surface of the other stationary element across a gap. The first and second stationary elements are electrically isolated from each other. The apparatus further includes a second geometry comprising a rotatable element disposed in the gap and configured to rotate between the first and second stationary elements. The rotatable element is electrically conductive such that a first electric field is generated between the first stationary element and the rotatable element and a second electric field is generated between the rotatable element and the second stationary element in response to application of a voltage difference applied across the first and second stationary elements.

### RELATED APPLICATION

This application is a non-provisional patent application claiming priority to U.S. Provisional Patent Application No. 63/523,858, filed Jun. 27, 2023, titled “Rheometer for Simultaneous Rheological and Electrical Measurements,” which is incorporated herein by reference.

### FIELD OF THE INVENTION

The disclosed technology relates generally to rheological and electrical characterization of materials. More particularly, the technology relates to an apparatus for performing simultaneous electrical and rheological measurements of test samples.

### BACKGROUND

Simultaneously measuring electrical and rheological properties of a material sample enable correlation of changes in the electrical and rheological properties. To enable such measurements, an electric field is established in the sample and electrical properties are measured across the stress/strain gradient during rheological measurements.

Current state of the art systems achieve concurrent electrical and rheological measurements by using the moving and stationary geometries of a rheological instrument as electrodes of opposite polarity such that electrical current flows from one electrode through the sample to the other electrode. Liquid or sliding friction contacts are employed to conduct current between the continuously moving geometry and the stationary geometry. Potassium chloride solution and liquid metal alloys are examples of conductive liquids that are sometimes used to make electrical contact with the moving geometry. Spring brushes may be used as sliding friction contacts. The liquid or sliding friction contacts add undesirable friction torque to the rheological measurement and undesirable electrical impedance to the electrical impedance measurement. Consequently, the resolution of both types of measurements is decreased due to a degradation in the signal to noise ratio. In combined motor transducer rheometers the undesirable friction is particularly problematic. More specifically, the torque required to rotate the moving geometry is also used to determine sample material property data, therefore the instrument measurement sensitivity is limited by additional sources of torque that are independent of torque imparted by the sample.

### SUMMARY

In one aspect, an apparatus for measuring rheological and electrical properties of a sample includes a stationary geometry that includes a double wall concentric cylinder having a cylinder axis, an outer wall, an inner wall and a gap defined between the outer wall and the inner wall. The outer and inner walls are electrically conductive and are electrically isolated from each other. The apparatus further includes a moving geometry that includes a cylindrical bob disposed in the gap and rotatable about the cylinder axis. The cylindrical bob is electrically conductive. An outer sample gap is defined between the cylindrical bob and the outer wall and an inner sample gap is defined between the cylindrical bob and the inner wall.

The apparatus may further include a motor shaft coupled to the cylindrical bob through an electrically insulating element. The apparatus may additionally include a motor coupled to the motor shaft and a voltage source in communication with the outer wall through a first electrically conductive path and in communication with the inner wall through a second electrically conducive path.

The outer and inner walls may be secured to an electrically insulating base and the electrically insulating base may include a thermally conductive material. One or more electrodes may be disposed inside the electrically insulating base. A temperature controller may be in thermal communication with the electrically insulating base. A fluid channel that passes through the electrically insulating base and the inner wall may be included to conduct a flow of a heat transfer fluid. A fluid channel that passes through the stationary geometry may be included.

In another aspect, an apparatus for measuring rheological and electrical properties of a sample includes a moving geometry, a shaft and a stationary geometry. The moving geometry includes a rotatable plate formed of an electrically conductive material and having an electrically insulating hub. The shaft extends from the electrically insulating hub along an axis of rotation and is configured to rotate the rotatable plate about the axis of rotation. The stationary geometry includes a first stationary plate and a second stationary plate each formed of an electrically conductive material and spaced apart from each other to define a gap. The rotatable plate is disposed in the gap. The first stationary plate has a central opening to pass the shaft and the second stationary plate has an electrically insulating hub arranged opposite to the electrically insulating hub of the rotatable plate.

The apparatus may further include an electrically insulating side wall disposed circumferentially about the gap and about an outer edge of each of the first and second stationary plates. The electrically insulating side wall is configured to rotate about the axis of rotation at a wall angular velocity that is substantially equal to an angular velocity of the rotatable plate.

A radius of the rotatable plate may be less than a radius of the first stationary plate and less than a radius of the second stationary plate.

In still another aspect, an apparatus for measuring rheological and electrical properties of a sample includes a first geometry having a first and a second stationary element each being electrically conductive and having a surface disposed to face the surface of the other across a gap. The first and second stationary elements are electrically isolated from each other. The apparatus further includes a second geometry having a rotatable element disposed in the gap and configured to rotate between the first and second stationary elements. The rotatable element is electrically conductive such that a first electric field is generated between the first stationary element and the rotatable element and a second electric field is generated between the rotatable element and the second stationary element in response to application of a voltage applied across the first and second stationary elements.

In yet another aspect, an apparatus for measuring rheological and electrical properties of a sample includes a first geometry having a stationary element with a first electrically conductive region and a first surface. The apparatus further includes a second geometry comprising a rotatable element having an electrically conductive region and a second surface. The second geometry is separated from the first geometry across a gap defined between the first and second surfaces. The first and second electrically conductive regions are arranged opposite to each other across the gap. An electric field is generated between the first and second electrically conductive regions across the gap in response to an application of a voltage applied across the first and second electrically conductive regions.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 is an illustration of a known rheometer used to measure rheological and electrical properties of a sample.

FIG. 2 is a cross-sectional side view illustration of a rheometer having a double walled cup measurement geometry in accordance with an embodiment of the present inventive concept.

FIG. 3 is a cross-sectional side view illustration of another embodiment of a rheometer having a double walled cup measurement geometry.

FIG. 4 is a cross-sectional side view illustration of another embodiment of a rheometer having a double walled cup measurement geometry.

FIG. 5 is a cross-sectional side view illustration of another embodiment of a rheometer having a double walled cup measurement geometry.

FIG. 6 is a cross-sectional side view illustration of a rheometer having a parallel plate measurement geometry in accordance with an embodiment of the present inventive concept.

FIG. 7 is a cross-sectional side view illustration of another embodiment of a rheometer having a parallel plate measurement geometry.

FIGS. 8A and 8B are simplified cross-sectional side and vertical views, respectively, of another embodiment of a rheometer having a concentric cylinder measurement geometry.

FIG. 9 is a simplified cross-sectional side view of another embodiment of a rheometer having a concentric cylinder measurement geometry.

FIG. 10 is a simplified cross-sectional side view of another embodiment of a rheometer having a concentric cylinder measurement geometry.

FIG. 11 is a simplified cross-sectional side view of another embodiment of a rheometer having a concentric cylinder measurement geometry.

### DETAILED DESCRIPTION

Reference in the specification to an embodiment or example means that a particular feature, structure, or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

Various terminology is used in the following description. As used herein, the term “geometry” relates to one or more components used to generate the desired stress or strain in a sample. For example, for a sample disposed between two horizontally arranged parallel plates where one of the plates rotates with respect to the other plate, the rotating plate may be referred to as the moving geometry and the stationary plate referred to as the stationary geometry. Alternatively, one plate may simply be referred to as the upper geometry while the other plate is referred to as the lower geometry. Similarly, geometries are associated with other rheometer arrangements such as concentric cylinders in which one cylinder remains stationary while the other cylinder rotates about the cylinder axis.

As used herein, “electrode” means an electrically conductive element used to establish an electric field between the element and another electrically conductive element. In the examples described below, an electrode can refer to an electrically conductive component such as a metal plate geometry in a parallel plate rheometer or part or all of a wall in a double walled cup measurement geometry.

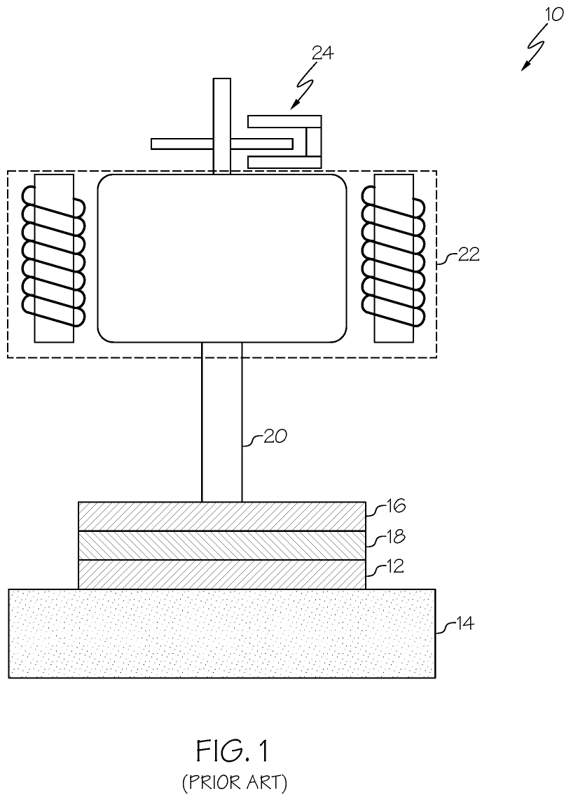

FIG. 1 is a schematic depiction of a known rheometer 10 that can be used to measure rheological and electrical properties of a sample. The rheometer 10 includes a lower stationary geometry 12 on a larger plate or block 14. In some implementations, thermal control of the sample temperature can be achieved via a thermal controller in thermal communication with the lower geometry through the plate 14. The rheometer 10 further includes an upper geometry 16 separated from the lower geometry 12 by a sample gap which is occupied by the sample 18 under test. A shaft 20 couples the upper geometry 16 to a combined motor transducer 22 that is cushioned by air and levitated. The current supplied to the motor 22 provides the torque to rotate the upper geometry 16 and a displacement sensor 24 provides a means of sensing the rotational displacement. For example, the displacement sensor 24 can be an optical encoder and optical sensor. The motor current is monitored to sense the torque applied to the sample 18.

To generate an electric field across the sample 18, a voltage difference is applied across the lower and upper geometries 12, 16. This is achieved by electrically coupling the lower geometry 12 to a terminal of a voltage source and electrically coupling the upper moving geometry 16 to the other terminal of the voltage source. For example, the contacts used to apply a voltage to the upper geometry 16 may include a conductive liquid or a sliding friction contact. Such contacts have their own impedance characteristics that make measurements of the sample impedance difficult and can degrade the signal to noise ratio of the sample measurement signals.

In the illustrated rheometer 10, the lower and upper geometries 12, 16 are circular disks; however, it will be recognized that other measurement geometry configurations can be similarly used to generate an electric field across the sample 18. For example, the two geometries can be concentric cylindrical walls separated by a sample gap wherein one of the cylindrical walls rotates with respect to the other cylindrical wall. These configurations are also degraded by the presence of electrical contacts present on the moving geometry.

In brief overview, embodiments and examples disclosed herein are directed to an apparatus for measuring rheological and electrical properties of a sample. Described embodiments are directed to rheometers in which the moving geometry is electrically isolated from the stationary geometry and the voltage is applied between two stationary components or regions of the rheometer. For example, the stationary components can be two electrically isolated elements of the stationary geometry. For a rheometer having a double wall electric cup arrangement in which the moving geometry occupies the gap between the two stationary cylindrical walls, one electrode is defined on the stationary inner wall and the other electrode is defined on the stationary outer wall. A voltage applied across the electrodes generates the electric field across the gap between the walls which contains the sample and the moving geometry. For a rheometer having a parallel plate arrangement, the moving geometry can be a rotatable plate that is parallel to and disposed between two stationary parallel plates. In this configuration, each electrode is attached to a respective one of the stationary and electrically isolated plates so that a voltage difference can be generated across the gap between the stationary parallel plates where the sample and rotatable geometry are present.

Advantageously, measurement data acquired using the apparatus is not adversely impacted by the electrodes used to generate the electric field across the sample. Apparatus described herein enable a more accurate determination of the dielectric properties of a sample and how these properties relate to the measured mechanical properties. Measurements can be performed at a single frequency for an applied voltage while changing the shear rate, at a single shear rate while changing the frequency of the applied voltage or changing both the applied voltage frequency and shear rate. These measurements can be performed at a single sample temperature or over a range of temperatures.

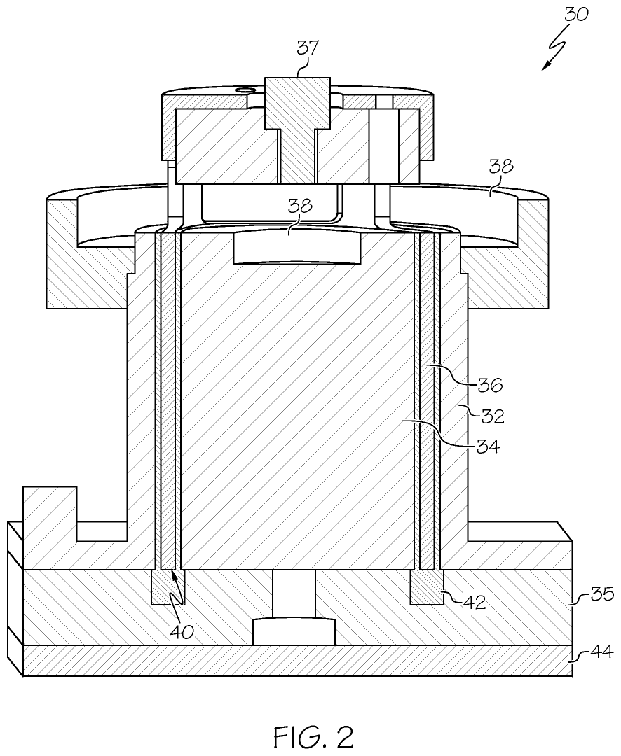

FIG. 2 is a cross-sectional side view illustration of a rheometer 30 having a double walled cup measurement geometry. The rheometer 30 includes a stationary outer wall 32 disposed coaxially about a stationary inner wall 34 to define a radial gap between the walls. The two stationary walls 32, 34 are secured in a base 35 made of an electrically insulating material. By way of non-limiting examples where temperature control is not a concern, polyether ether ketone (PEEK), acetyl and other polymer materials may be used at lower to moderate temperatures. At higher temperatures, such as for polymer melt experiments, a ceramic insulator can be used. In an oven where convection of air over the side of the plates may provide temperature control, a ceramic such as Macor® may be preferred for case of manufacture. A protective coating may be applied to any wetted surface of the ceramic to protect the surface from the sample. The moving geometry is defined by an electrically conductive cylindrical bob 36 in the form of a cylindrical wall disposed in the gap between the stationary cylindrical walls 32, 34. The cylindrical wall 36 is electrically isolated with respect to the motor shaft 37, for example, by an electrically insulating structure or coupling 38. Due to the small radial gap relative to the length of the edge 40 (bottom portion) of the cylindrical wall 36 and the significantly greater surface areas on the opposing cylindrical walls 32, 34 relative to the surface area of the edge 40, most of the torque is due to the sample gap and edge effects can generally be ignored. Similarly, electrical conductance and electrical capacitance in the radial sample gap are both large compared to that at the edge 40 of the cylindrical wall 36, thereby edge effects are generally negligible. Notwithstanding, in some applications it can be desirable to reduce the area of the bob 36 in the region above the opposing walls 32, 34 to reduce both the capacitance, conductance, and shear area outside the measurement zone.

A wire or other form of electrical connection can be secured to the stationary outer wall 32 and to the stationary inner wall 34 to couple to corresponding terminals of a voltage source so that a static or alternating voltage can be applied across the radial gap. By using only stationary components for the electrodes, no extraneous torque is added by the electrical measurement and greater rheology measurement sensitivity is realized. Electrical couplings may be provided on the corresponding stationary components for easy attachment of wires or cables leading to the voltage source and measurement instrumentation. Advantageously, electrical measurement sensitivity is improved with respect to rheometers where one or more electrodes are in contact with the moving geometry.

When a voltage difference exists between the outer and inner walls 32, 34, electric field lines and current flow are radially oriented across the sample 42 from the outer wall 32 to the conductive moving cylindrical wall 36 and to the inner wall 34 or vice versa if the voltage polarity is reversed.

The rheometer measurements allow for direct correlation of changes in electrical conductivity and capacitance to changes in the shear stress, strain and strain rate by simultaneously measuring voltage and current flow between the electrodes while measuring torque and rotational displacement and velocity. For example, the electrical measurement may use an impedance meter (e.g., an LCR meter) to measure the impedance and/or dielectric properties of the sample by applying an alternating voltage across the outer and inner walls 32, 34 and measuring the current at different frequencies.

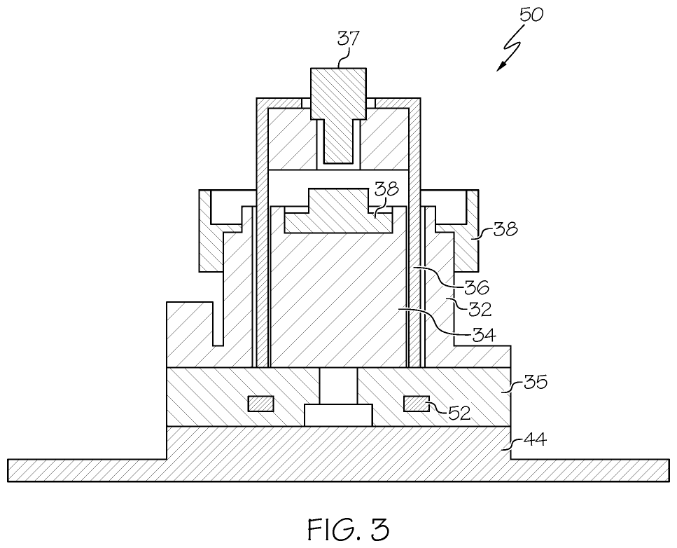

FIG. 3 shows a cross-sectional side view of a rheometer 50 that is constructed similar to the rheometer of FIG. 2; however, an additional electrode 52 is included. The additional electrode 52 is circular and can be maintained at a different voltage than the outer and inner walls 32, 34. As illustrated, the additional electrode 52 is disposed inside the electrically insulating base 35. The additional electrode 52 may be coupled to a reference voltage used as a comparison voltage with respect to the voltages used to generate the electric field across the sample gap.

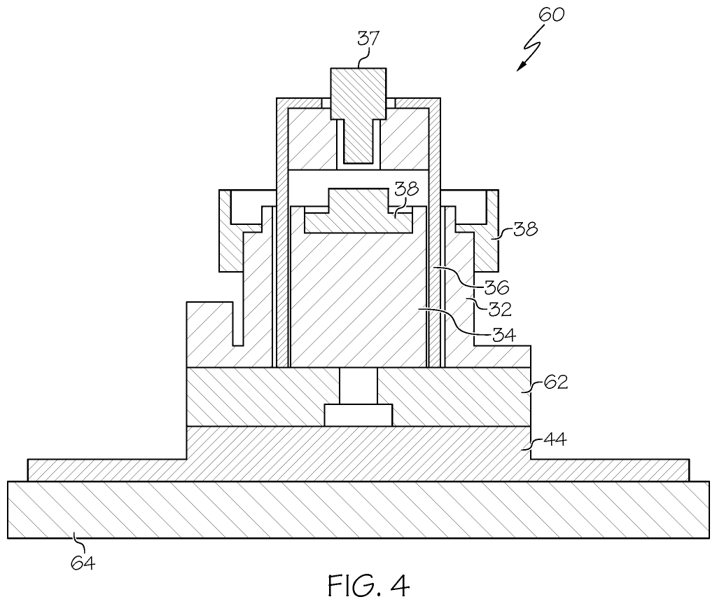

In some implementations, one or more of the electrically insulating parts are manufactured from a material having high thermal conductivity to allow for accurate control of the sample temperature. For example, a base 62 formed of a thermally conductive material can facilitate heat flow between the stationary walls 32, 34 and an external temperature controller 64, as shown in FIG. 4. Additionally, electrically insulating parts 38 used to electrically isolate the moving geometry can be made from a thermally conductive material to enable better thermal control of the moving geometry using the temperature controller 64. By way of non-limiting examples, the thermally conductive material for the base 62 and/or the electrically insulating parts 38 include aluminum nitride, alumina, silicon nitride and other thermally conductive ceramics.

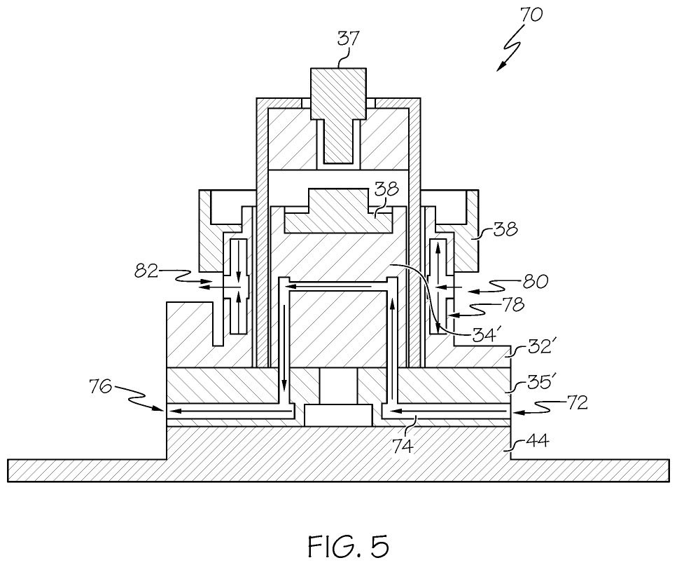

FIG. 5 shows a rheometer 70 with a configuration similar to the rheometer of FIG. 4; however, the temperature controller 64 is absent and a heat transfer fluid is used for temperature control. Preferably, the heat transfer fluid is an electrically insulating fluid such as air or silicone oil. The fluid is received at an inlet port 72 in the electrically insulating base 35′ and flows (as shown by arrows) through a fluid channel 74 to an outlet port 76. The fluid channel 74 passes through the base 35′ and through the inner wall 34′ before returning through the base 35′ to the outlet port 76. A second fluid channel 78 extending between an inlet port 80 and an outlet port 82 on the outer wall 32′ may be used to pass the heat transfer fluid. It will be appreciated that alternative channel paths to those shown may be provided within the corresponding components 35′, 32′ according to specific heat transfer requirements and manufacturability limitations.

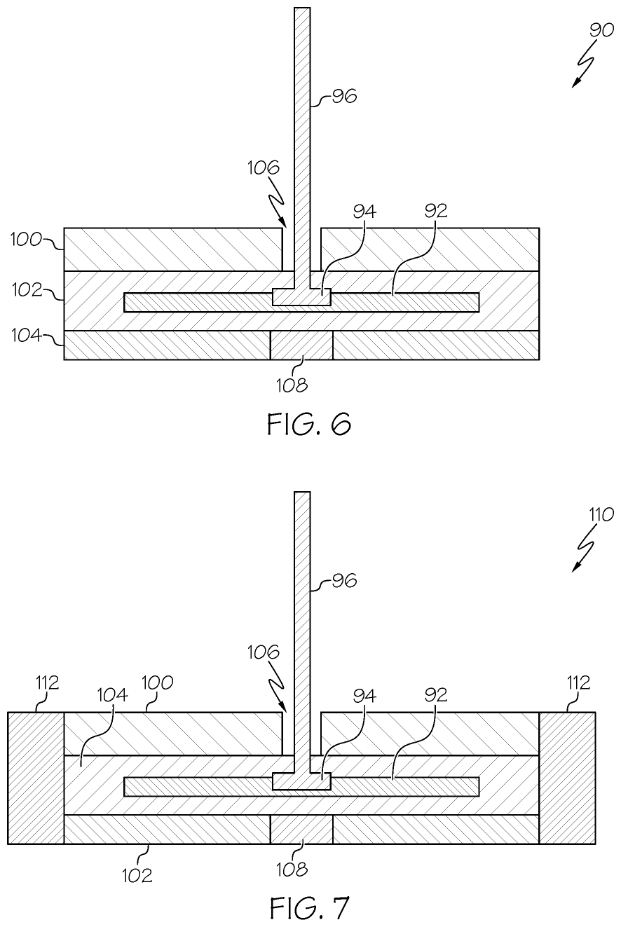

FIG. 6 shows a cross-sectional side view of an example of a rheometer 90 having a parallel plate measurement geometry. A first (moving) geometry includes a rotatable plate 92 formed of an electrically conductive material and having an electrically insulating hub 94. A shaft 96 extends from the hub 94 along an axis of rotation to a motor (not shown) that operates to rotate the plate 92. A second (stationary) geometry includes a pair of parallel plates 100 and 102 which remain stationary during measurements. Each stationary plate 100, 102 is made of an electrically conductive material and is spaced apart from the other plate to define a gap therebetween. The rotatable plate 92 is disposed in the gap and the sample occupies the volume of the gap exclusive of the volume occupied by the rotatable plate 92 and the lower end of the shaft 96. The upper stationary plate 100 has a central opening 106 to pass the shaft 96 and the second stationary plate 102 has an electrically insulating hub 108 that is disposed opposite to the hub 94 on the rotatable plate 92.

The upper stationary plate 100 is coupled to one terminal of a voltage source and the lower stationary plate 102 is coupled to the other terminal of the voltage source so that a controlled voltage can be applied across the full sample gap. The intervening rotatable plate 92 separates the sample gap into a first gap defined between the upper plate 100 and the rotatable plate 92 and a second gap between the rotatable plate 92 and the lower plate 102. The radius of the rotatable plate 92 is preferably less than the radii of the upper and lower stationary plates 100,102 to reduce edge effects. Similarly, the size of the first and second gaps are small with respect to the radial dimensions of the stationary and rotatable plates 92, 100, 102 to further reduce edge effects.

FIG. 7 shows another example of a rheometer 110 having a parallel plate measurement geometry. In this example, the rheometer 110 includes a side wall 112 comprising one or more wall segments circumferentially disposed about the upper and lower stationary plates 100, 102 and sample gap. In some implementations, the side wall 112 is configured to rotate about the axis of rotation defined by the shaft 96. Preferably, rotation is at an angular velocity that is approximately the same as the angular velocity of the rotatable plate 92 to minimize any torque resulting from the presence of the side wall 112 which can degrade measurement accuracy. The side wall 112 is made of an electrically insulating material to maintain electrical isolation between the upper and lower stationary plates 100, 102.

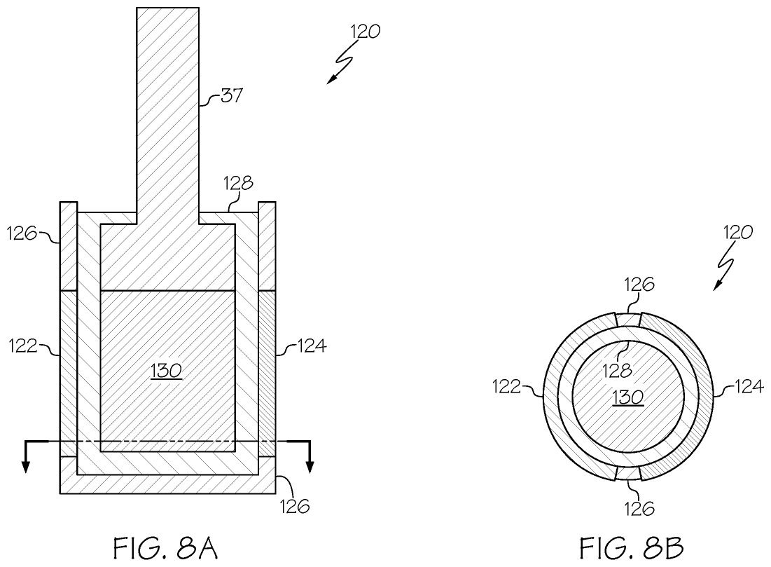

Additional embodiments of rheometers according to the principles described herein are shown in FIGS. 8A to 11. Each configuration may have distinct advantages over other configurations and may be suitable for specific needs for rheological and electrical property measurements of a sample.

FIGS. 8A and 8B show a simplified cross-sectional side view and vertical view, respectively, of another example of a rheometer 120 having a concentric cylinder measurement geometry. The rheometer 120 is structurally similar to the rheometer 30 of FIG. 2; however, instead of applying a voltage difference between the outer and inner walls, the voltage is applied between a first conductive region 122 and a second conductive region 124 of the outer wall 126. More specifically, the first and second conductive regions 122, 124 are similarly sized and arranged diametrically opposite to each other. Additionally, the sample 128 occupies the gap between the outer and inner walls 126, 130 as well as underneath a bottom end of the inner wall defined by a flat circular region that is perpendicular to the cylindrical side. A pair of electrically insulating vertical portions of the outer wall 126 separate the two conductive regions 122, 124. Thus, the circumferential extent of each of the conductive regions 122, 124 is less than 180° about the axis of rotation. When a voltage difference is applied across the two conductive regions 122, 124, the radial direction of the electric field generated between the conductive portion 122 and the inner wall 130 is opposite to the radial direction of the electric field generated between the other conductive portion 124 and the inner wall 126. In this configuration, if the circumferential extent of each non-conductive region 132 is small with respect to the circumferential extent of each conductive region 122, 124, then most of the sample 128 in the cylindrical sample gap is exposed to one of the electric field regions to improve measurement sensitivity.

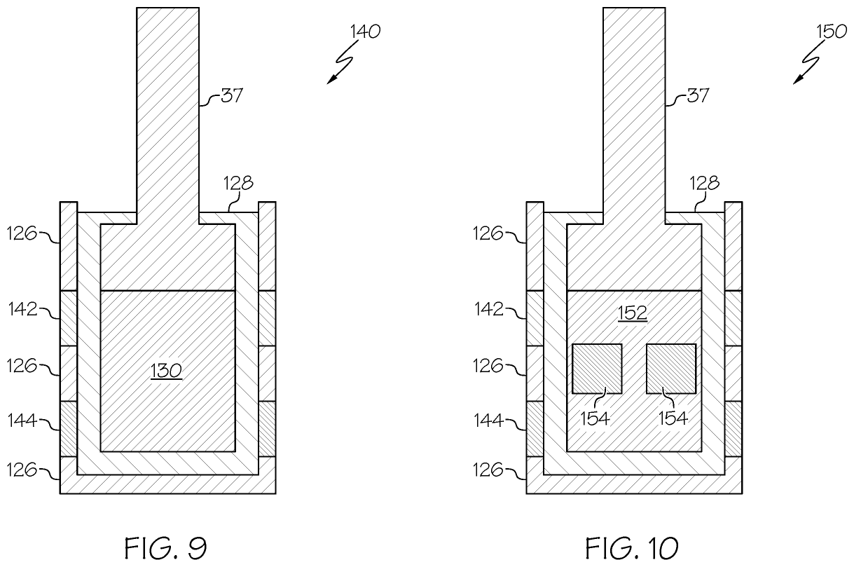

FIG. 9 shows a simplified cross-sectional side view of an example of a rheometer 140 having a concentric cylinder measurement geometry. The illustrated rheometer 140 is similar in structure to the rheometer 120 of FIGS. 8A and 8B; however, there are two separate electrically conductive regions 142, 144 in the stationary outer wall 126 where each conductive region 142, 144 extends circumferentially for a full 360° and is vertically separated from the other conductive region by an electrically insulting portion of the outer wall 126. In this configuration, the electric field generated between the upper conductive region 142 and the inner wall 130 is directed in a radially opposite direction to the electric field generated between the lower conductive region 144 and the inner wall 130.

FIG. 10 shows a simplified cross-sectional side view of a modified version of the rheometer 140 of FIG. 9. The illustrated rheometer 150 includes an inner wall 152 having an electrically insulating ring 154 that extends circumferentially for 360°. The insulating ring 154 has approximately the same vertical height as the “middle” region of the outer wall 126 (i.e., the region that separates the two conductive regions 142, 144). The insulating ring 154 is disposed on the opposite side of the sample 128 from the middle region of the outer wall 126. The portions of the inner wall 152 that are above and below the insulting ring 154 remain electrically coupled to each other and therefore are at the same voltage. In this arrangement, the radial electric fields are better confined to be more parallel to the shear gradient for the sample.

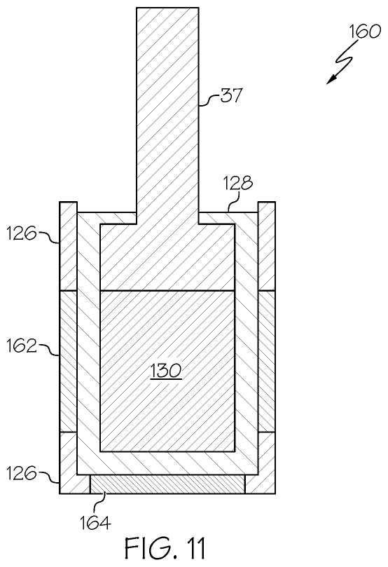

FIG. 11 shows a simplified cross-sectional side view of another rheometer 160 which can be seen as a modification of the rheometer 140 of FIG. 9. A first conductive region 162 extends 360° around the inner wall 126. A second conductive region 164 is provided at the bottom across the horizontal portion of the sample 128 in the sample gap. Thus, one electric field is generated in a radial direction across the sample 128 between the first conductive region 162 and the inner wall 130 and a second electric field is generated in a vertical direction across the sample 128 at the bottom portion of the sample gap between the second conductive region 164 and the inner wall 130.

In the various examples described above, it is preferential, but not required that the shear rate within the sample gap or sample gaps be constant. For example, using a double walled cup measurement geometry as illustrated in FIG. 2, it is desirable that the shear rate between the rotating upper geometry and the outer wall be the same as the shear rate between the rotating upper geometry and the inner wall. Referring to the rheometer 30 of FIG. 2, this is accomplished by controlling the size of the gap between the stationary outer wall 32 and the cylindrical wall 36 and the size of the gap between the cylindrical wall 36 and the stationary inner wall 34.

While various examples have been shown and described, the description is intended to be exemplary, rather than limiting and it should be understood by those of ordinary skill in the art that various changes in form and detail may be made therein without departing from the scope of the invention as recited in the accompanying claims. For example, it should be appreciated that electrically conductive parts and electrically insulating parts are not limited to a single piece or part. For example, it may be desirable to manufacture such components from more than one piece to address manufacturability and usability concerns. Moreover, although the embodiments described above include electrically insulating parts, such parts may be substituted by electrically insulating plating between conductive parts as long as the electrical conductance and capacitance of the plating is sufficiently low with respect to the sample so that the measurement is not adversely affected.

What is claimed is:

1. An apparatus for measuring rheological and electrical properties of a sample comprising:
a stationary geometry comprising a double wall concentric cylinder having a cylinder axis, an outer wall, an inner wall and a gap defined between the outer wall and the inner wall, the outer and inner walls being electrically conductive and being electrically isolated from each other; and
a moving geometry comprising a cylindrical bob disposed in the gap and rotatable about the cylinder axis, wherein the cylindrical bob is electrically conductive and wherein an outer sample gap is defined between the cylindrical bob and the outer wall and an inner sample gap is defined between the cylindrical bob and the inner wall.

2. The apparatus of claim 1, further comprising a motor shaft coupled to the cylindrical bob through an electrically insulating element.

3. The apparatus of claim 1, wherein the outer and inner walls are secured to an electrically insulating base.

4. The apparatus of claim 3, wherein the electrically insulating base comprises a thermally conductive material.

5. The apparatus of claim 2, further comprising a motor coupled to the motor shaft and a voltage source in communication with the outer wall through a first electrically conductive path and in communication with the inner wall through a second electrically conducive path.

6. The apparatus of claim 3, further comprising at least one electrode disposed inside the electrically insulating base.

7. The apparatus of claim 4, further comprising a temperature controller in thermal communication with the electrically insulating base.

8. The apparatus of claim 4, further comprising a fluid channel that passes through the electrically insulating base and the inner wall and configured to conduct a flow of a heat transfer fluid.

9. The apparatus of claim 4, further comprising a fluid channel that passes through the stationary geometry.

10. An apparatus for measuring rheological and electrical properties of a sample comprising:
a moving geometry comprising a rotatable plate formed of an electrically conductive material and having an electrically insulating hub;
a shaft extending from the electrically insulating hub along an axis of rotation and configured to rotate the rotatable plate about the axis of rotation; and
a stationary geometry comprising a first stationary plate and a second stationary plate each formed of an electrically conductive material and spaced apart from each other to define a gap therebetween in which the rotatable plate is disposed, the first stationary plate having a central opening to pass the shaft and the second stationary plate having an electrically insulating hub arranged opposite to the electrically insulating hub of the rotatable plate.

11. The apparatus of claim 10, further comprising an electrically insulating side wall disposed circumferentially about the gap and about an outer edge of each of the first and second stationary plates.

12. The apparatus of claim 11, wherein the electrically insulating side wall is configured to rotate about the axis of rotation at a wall angular velocity that is substantially equal to an angular velocity of the rotatable plate.

13. The apparatus of claim 10 wherein a radius of the rotatable plate is less than a radius of the first stationary plate and less than a radius of the second stationary plate.

14. An apparatus for measuring rheological and electrical properties of a sample comprising:
a first geometry comprising a first and a second stationary element each being electrically conductive and having a surface disposed to face the surface of the other across a gap, the first and second stationary elements being electrically isolated from each other; and
a second geometry comprising a rotatable element disposed in the gap and configured to rotate between the first and second stationary elements, the rotatable element being electrically conductive, wherein a first electric field is generated between the first stationary element and the rotatable element and a second electric field is generated between the rotatable element and the second stationary element in response to application of a voltage applied across the first and second stationary elements.

15. An apparatus for measuring rheological and electrical properties of a sample comprising:
a first geometry comprising a stationary element having a first electrically conductive region and a first surface; and
a second geometry comprising a rotatable element having an electrically conductive region and a second surface, the second geometry being separated from the first geometry across a gap defined between the first and second surfaces, wherein the first and second electrically conductive regions are arranged opposite to each other across the gap and wherein an electric field is generated between the first and second electrically conductive regions across the gap in response to an application of a voltage applied between the first and second electrically conductive regions.
